(19) United States
(12) Patent Application Publication
(10) Pub. No.: US 2014/0255130 A1
(43) Pub. Date: Sep. 11, 2014

(54) DOCK-TO-RAIL AND RAIL-TO-DOCK CONTAINER HANDLING SYSTEM AND METHOD

(71) Applicant: Virginia International Terminals, LLC, Portsmouth, VA (US)

(72) Inventors: William Pierangelino, Virginia Beach, VA (US); Matthew Plante, Norfolk, VA (US)

(73) Assignee: Virginia International Terminals, LLC, Portsmouth, VA (US)

(21) Appl. No.: 14/181,634

(22) Filed: Feb. 15, 2014

Related U.S. Application Data
(60) Provisional application No. 61/772,719, filed on Mar. 5, 2013.

(51) Int. Cl. B65G 63/00

(52) U.S. Cl. CPC B65G 63/004
USPC 414/141.3; 414/803

(57) ABSTRACT

A land-based shipping container handling system includes at least one transfer stack region. Each transfer stack region includes a rail mounted gantry (RMG) defining a three-dimensional operating region. At least one rail line and at least one row of shipping containers are maintained in the operating region. An elevated platform is disposed at one end of the operating region at an upper portion thereof. Attribute sensing equipment is mounted on the elevated platform.

Pursuant to 35 U.S.C. §119, the benefit of priority from provisional application 61/772,719, with a filing date of Mar. 5, 2013, is claimed for this non-provisional application.

### FIELD OF THE INVENTION

The invention relates generally to container handling, and more particularly to a system and method for handling container transfer between a dock and railcars.

### BACKGROUND OF THE INVENTION

ISO containers that are 20 feet or 40 feet in length are the standardized shipping containers used throughout the world to move goods over water, on rails, and over the road. The transfer of such shipping containers between seagoing vessels and railcars and/or over-the-road (“OTR”) vehicles occurs at a port. A typical state-of-the-art arrangement for handling such transfers will be described with the aid of FIGS. 1 and 2. Briefly, FIG. 1 illustrates an overview of the port arrangement and FIG. 2 illustrates an overview of a single “stack” of containers serviced by one or two rail mounted gantries (“RMG”) in the port's dockside container yard.

Referring first to FIG. 1, the port arrangement resides between an incoming rail line 100 and the port's dock 200, and is referenced by the structure within dashed line box 10. Port arrangement 10 includes a rail yard 12, a rail side container buffer zone 14, a dockside container yard 16, an import portal 18, and an export portal 20. Rail yard 12 is an area that typically has multiple lines of railroad track to receive incoming and outgoing trains loaded with containers. Container buffer zone 14 is an open land area for the temporary storage of containers unloaded from a train or about to be loaded on a train. Buffer zone 14 is designed to allow manually-driven port vehicles (also referred to in the art as conveyance vehicles) to enter with containers, deposit containers, and pick-up and leave with the containers. Dockside container yard 16 is another land area for storage of containers to be loaded onto a vessel from dock 200 and storage of containers off-loaded from a vessel to dock 200.

Container yard 16 is organized into what are known as “stacks” where a single stack consists of multiple rows of containers with each such row having a height that can be defined by multiple containers. An overview of a single stack is illustrated in FIG. 2 where rows of containers 300 are arranged between rails 302 that support (typically) two RMGs 304. As is well known in the art, RMGs 304 can move back and forth along rails 302, lift containers 300, and move containers to/between rows as needed.

Import portal 18 is a designated land area through which each incoming (imported) container must pass before it can enter buffer zone 14. Included at import portal 18 are cameras and radiation sensors/scanners. Export portal 20 is a designated land area through which each outgoing (exported) container must pass before going to container yard 16. Included at export portal 20 are cameras and a scale.

In terms of an incoming train loaded with containers for export on a seagoing vessel, the containers are off-loaded from the trains and transported via manually-driven port vehicles to buffer zone 14 as indicated by a traffic flow arrow 30. From buffer zone 14, the containers are manually-driven by port vehicles through export portal 20 as indicated by traffic flow arrow 32. The containers then continue on (via port vehicle) to dockside container yard 16 as indicated by flow arrow 34. A reverse traffic flow is used when import containers are to be loaded on the rail cars of a train. Briefly, port vehicles transport containers from container yard 16 to import portal 18 (as indicated by traffic flow arrow 40), then on to buffer zone 14 (as indicated by traffic flow arrow 42), and finally from buffer zone 14 to rail yard 12 (as indicated by traffic flow arrow 44).

The handling of containers using port arrangement 10 requires the use of many manually-driven port vehicles over a variety of loosely designated areas. There is substantial cost associated with the manpower needed to operate the port vehicles, monitor port vehicle traffic, and maintain the port vehicles. Furthermore, the sheer volume of such port vehicle traffic in port arrangement 10 presents a substantial risk of accident and injury. At a minimum, such risk is a costly insurance expense. Of greater concern are the consequences that could result from port vehicle accidents. In addition to the cost and safety issues associated with port vehicle use in port arrangement 10, the overall efficiency of port arrangement 10 is problematic during times of high activity. Loss of efficiency can be costly in terms of current profitability (i.e., longer throughput times equate to higher costs), as well as future profitability (i.e., loss of shipping traffic to a competing port).

### SUMMARY OF THE INVENTION

Accordingly, it is an object of the present invention to provide a container handling system and method for a port.

Another object of the present invention is to provide a container handling system and method that efficiently transfers containers between rail cars and a port's dock.

Other objects and advantages of the present invention will become more obvious hereinafter in the specification and drawings.

In accordance with the present invention, a land-based shipping container handling system includes at least one transfer stack region. Each transfer stack region includes a rail mounted gantry (RMG) defining a three-dimensional operating region. At least one rail line is disposed on the ground in the operating region and extends therefrom. A land area defined on the ground in the operating region is adjacent to the at least one rail line for supporting storage of at least one row of shipping containers. An elevated platform is disposed at one end of the operating region at an upper portion thereof. Attribute sensing equipment is mounted on the elevated platform.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is an overview of a port arrangement that handles the transfer of containers between rail cars and a dock in accordance with conventional technology;

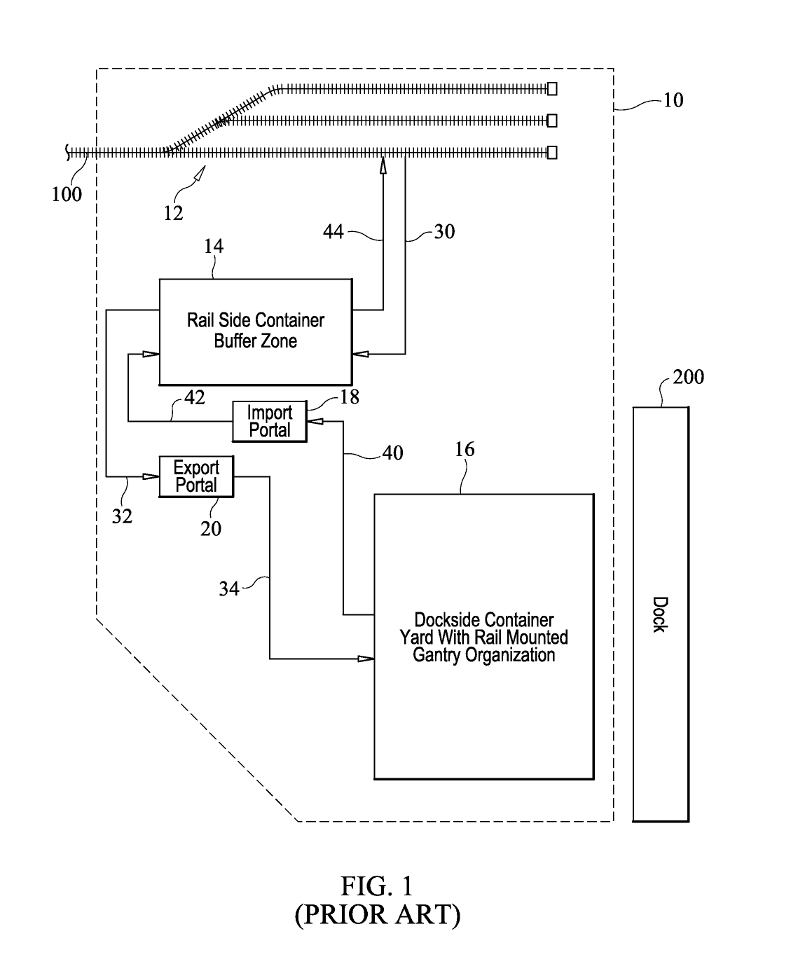

FIG. 2 is an overview of a container stack with rail mounted gantry organization in accordance with conventional technology;

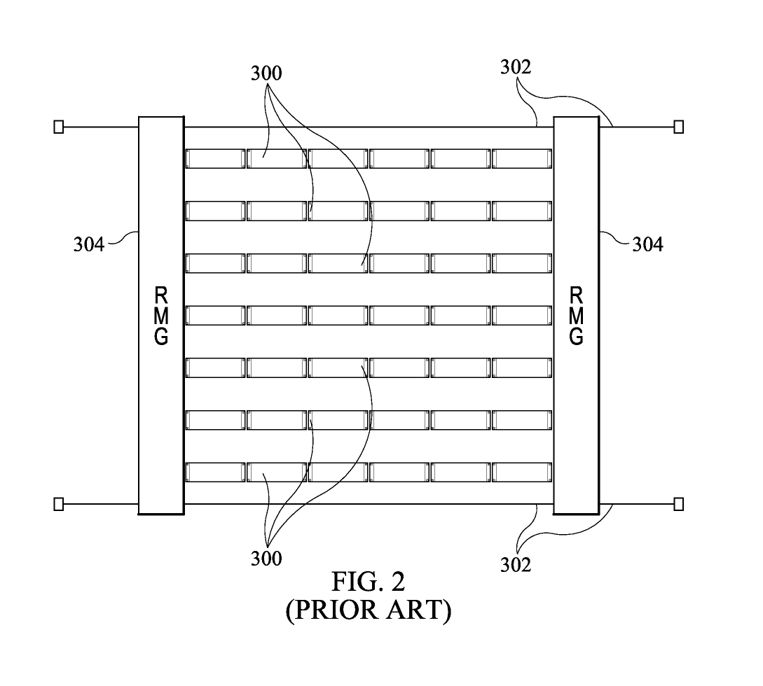

FIG. 3 is an overview of a container handling system for a port in accordance with an embodiment of the present invention;

FIG. 4 is a perspective view of a portion of a transfer stack region in accordance with an embodiment of the present invention;

FIG. 5 is a dockside end view of a transfer stack region in accordance with an embodiment of the present invention; and

FIG. 6 is an overview of a container handling system for a port in accordance with another embodiment of the present invention.

### DETAILED DESCRIPTION OF THE INVENTION

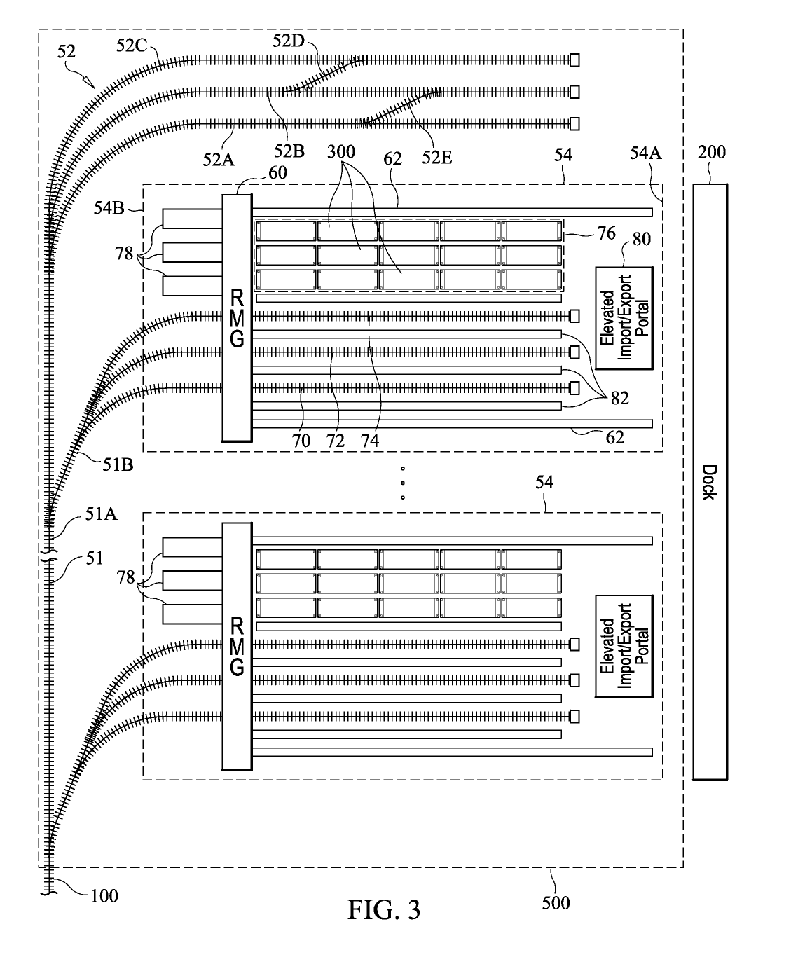

Referring again to the drawings and more particularly to FIG. 3, a land-based container handling system in accordance with an embodiment of the present invention is shown and is referenced by the structure and elements within dashed line box 50. Container handling system 50 provides for the efficient transfer of shipping containers between rail cars arriving/departing via rail line 100 and a port's dock 200. Accordingly, container handling system 50 is located at a parcel of land adjacent to dock 200. As used herein, the term “container” refers to standard ISO shipping containers, the constructions of which are well known in the art. Rail line 100 and dock 200 are not part of or a limitation on the present invention. As will become evident by the description to follow, container handling system 50 virtually eliminates the use of OTR vehicles in the container transfer process, while also streamlining the container transfer process resulting in substantial cost savings and greatly enhanced port/personnel safety.

Container handling system 50 includes a train marshaling yard 52 and one (or more) three-dimensional transfer stack regions 54. Marshaling yard 52 is connected to rail line 100 by a connecting rail line 51 with switches 51A positioned therealong for coupling to branch rail lines 51B. Each branch rail line 51B leads to one transfer stack region 54. Marshaling yard 52 is a land area with a number of rail lines (e.g., rail lines 52A, 52B, 52C) and switch mechanisms (e.g., switches 52D, 52E) that allow empty or loaded trains to be assembled/configured as needed prior to or after visiting a transfer stack region 54. The size of marshaling yard 52, number of rail lines, and/or mechanisms used for train assembly/configuration can include more or less rails and supporting elements/systems without departing from the scope of the present invention.

Each transfer stack region 54 is similarly constructed so that a description of one will be sufficient to provide an understanding of the present invention. Each transfer stack region 54 extends from one end 54A adjacent dock 200 to a second end 54B some distance from dock 200. Briefly, each transfer stack region 54 includes at least one RMG, one or more rail lines fitted within the operational confines of the RMG(s), a land area for stacking one or more rows of containers fitted within the operational confines of the RMG(s), and an elevated import/export portal fitted within the operational confines of the RMG(s).

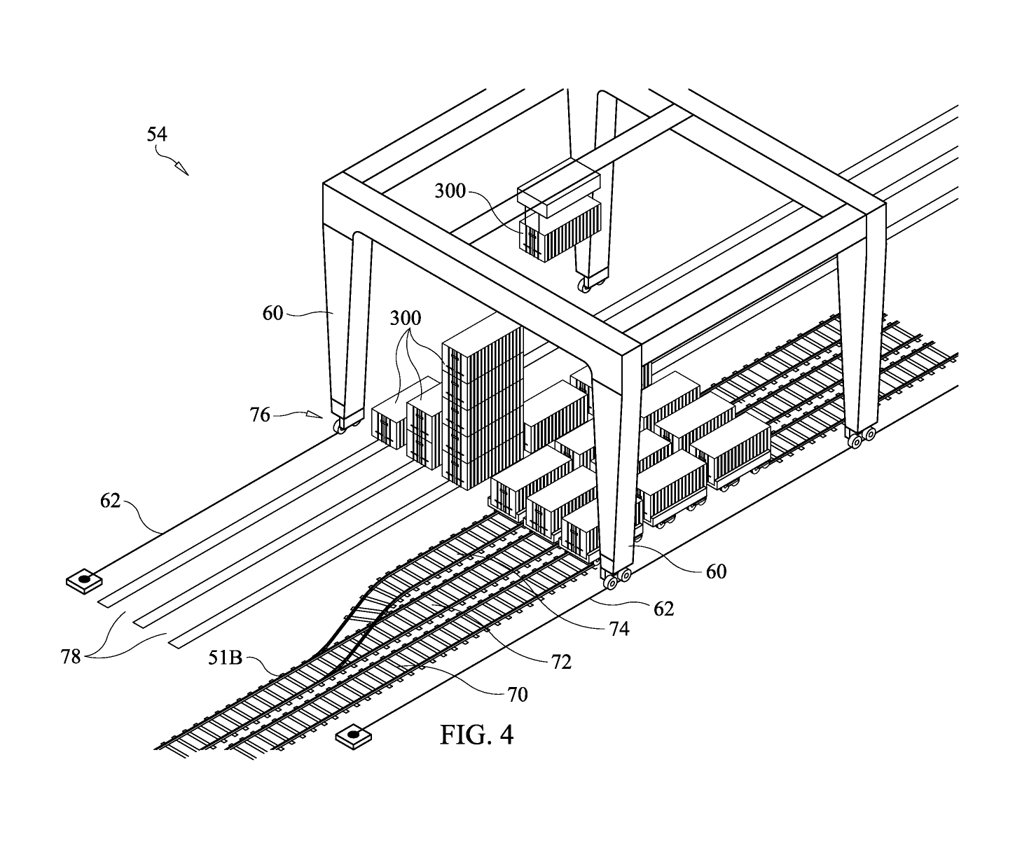

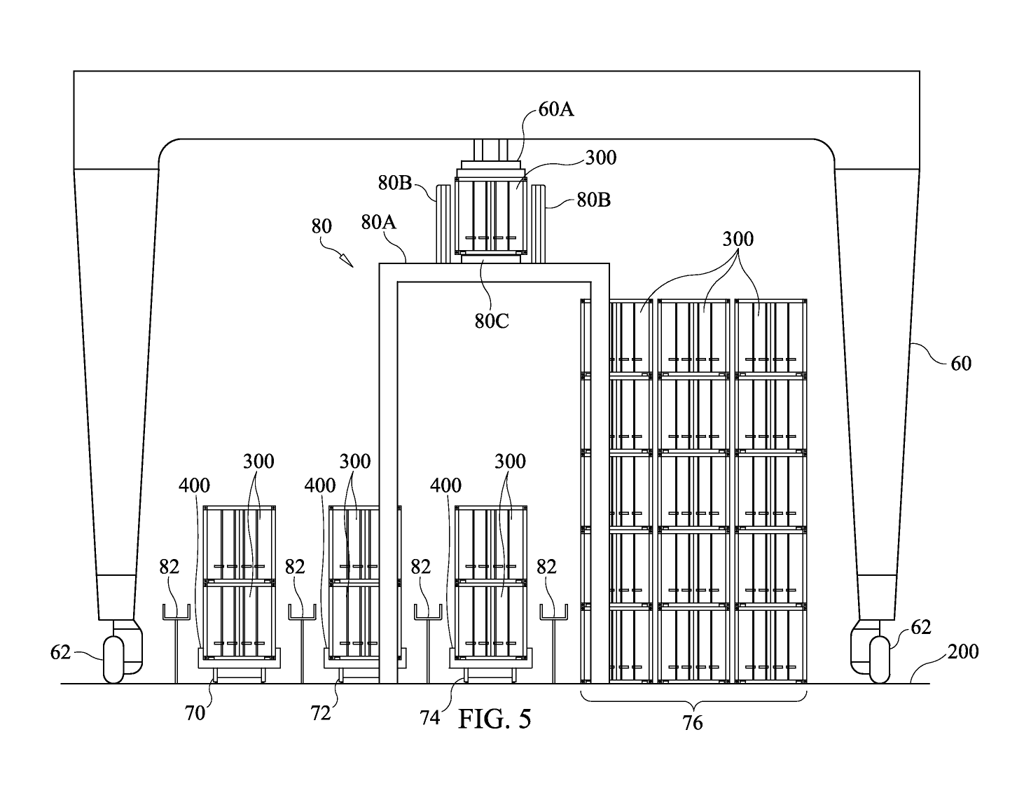

Referring additionally to the perspective view of end 54B shown in FIG. 4 and the end view of the dockside end 54A shown in FIG. 5, a more detailed description of transfer stack region 54 will be provided. The combination of RMG 60 and its rails 62 more or less define the footprint and volume of the operational confines of transfer stack region 54 that extends from the ground up to the top of the RMG's container lifting and movement capabilities. Note that transfer stack region 54 can include additional RMGs supported on rails 62 without departing from the scope of the present invention.

Fitted within the confines of RMG 60 and rails 62 are at least one rail line (e.g., three parallel and adjacent rail lines 70, 72 and 74 in the illustrated embodiment), and an area 76 for at least one stackable row of containers (e.g., three parallel and adjacent stackable rows of containers 300 in the illustrated embodiment). It is to be understood that the number of rail lines and rows of containers provided in a transfer stack region can be adjusted without departing from the scope of the present invention. Also, the length of rail lines 70/72/74 and area 76 can be adjusted to suit a particular application, site, etc., without departing from the scope of the present invention. One or more truck lanes 78 can be provided on the land side of area 76 (i.e., near end 54B of transfer stack region 54) such that trucks (not shown) can have containers 300 loaded directly thereon or therefrom. At the dockside end 54A of transfer stack region 54 is an elevated import/export portal 80 equipped with all the necessary cameras, sensors, scanners, etc., needed to examine containers being imported and exported. That is, portal 80 supports equipment used to collect/sense data on various attributes of containers and their contents as the containers move through or rest on portal 80.

Referring additionally now to FIG. 5, an end view of transfer stack region 54 at the dockside end 54A thereof is illustrated to show the relationships between elevated import/export portal 80, rail lines 70/72/74 and area 76. Elevated import/export portal 80 fits within the footprint/volume of transfer stack region 54. More specifically, portal 80 defines an elevated sensing/scanning platform 80A on which various attribute sensing equipment (e.g., cameras, sensors, optical scanners, radiations scanners, scales, etc.) are mounted where such equipment is indicated generally at 80B. Attribute sensing equipment 80B senses and records various attributes (e.g., identity, ownership, weight, seal integrity, radiations levels, destination, etc.) of container 300 and its contents as is well understood in the art. A scale 80C can be incorporated in/on platform 80A between equipment 80B. Another option is to utilize attributes of RMG 60 to weigh each container 300. Platform 80A is located approximately at the top of the operational confines of RGM 60. Platform 80A will generally be sized to support both attribute sensing equipment 80 and various inspection personnel (e.g., Port Authority, Customs, etc.) in order to support container inspections procedures.

In operation, transfer of containers 300 between a transfer stack region 54 and dock 200 includes the exposure of each transferred container through/past equipment 80B. More specifically, any containers 300 in transfer stack region 54 (e.g., on a rail car 400, in area 76 to include a topmost one of the containers 300 in a row thereof, etc.) is retrieved and passed through equipment 80B (by the pick-up hand 60A of RMG 60) prior to being placed on dock 200. A container 300 retrieved from dock 200 is passed through equipment 80B prior to being placed directly on a rail car 400 or at any height in a row in area 76 to include the topmost position of a row in area 76. This same process is used for all containers being transferred between transfer stack region 54 and dock 200. Thus, transfer stack region 54 allows containers 300 to be transferred directly between dock 200 and rail cars 400 (on rail lines 70, 72 or 74) while satisfying all import/export regulations since they are passed through equipment 80B during such transfer.

In addition to the above-described features, transfer stack region 54 can include elevated walkways 82 adjacent to each side of each rail line 70, 72 and 74. Such elevated walkways run the length of each side of rail lines 70/72/74 and are situated at a height that allows an operator to reach adjacent corners of a two-high stack of containers on a rail car. This is illustrated in FIG. 5 where each rail car 400 has two containers 300 stacked thereon. As is known in the art, regulations require that stacked containers must be coupled at their adjacent corners using couplings (not shown). Accordingly, elevated walkways 82 allow a mechanic or landbridgeman to walk the entire length of a side of rail lines 70, 72 and 74 to install or remove such container couplings.

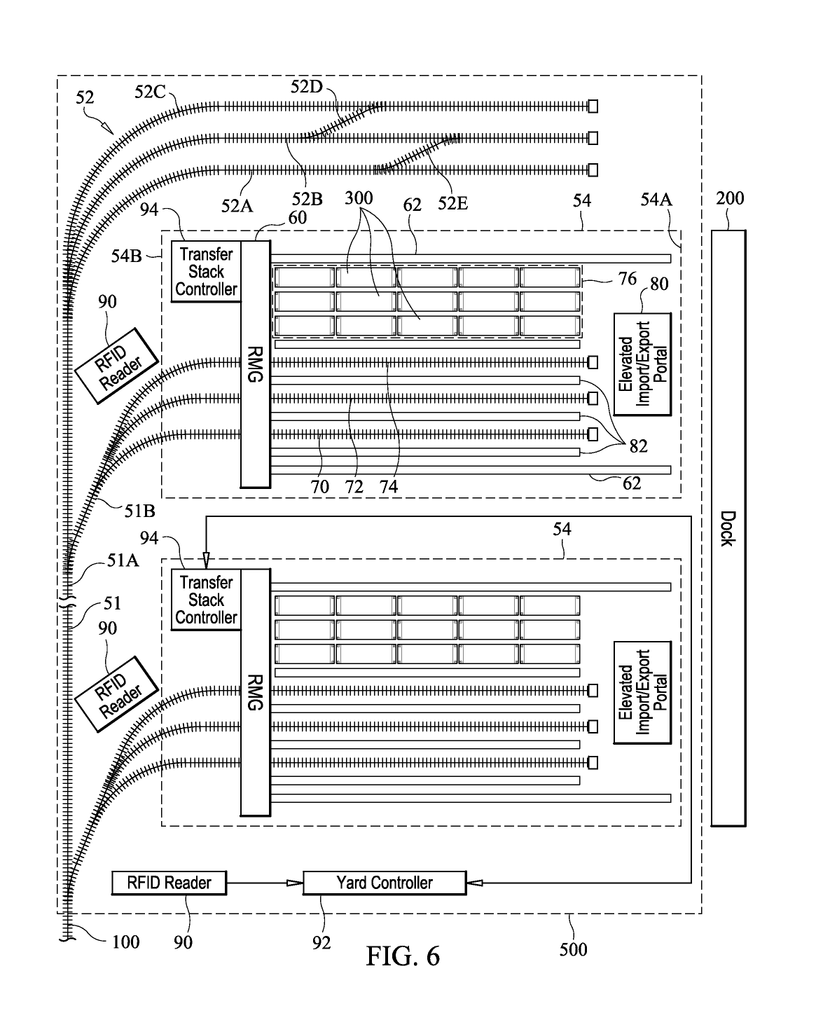

The container handling system of the present invention also lends itself to a substantial amount of automation. Referring now to FIG. 6, an automated embodiment of a container handling system in accordance with the present invention is shown and is referenced by the structures/elements within dashed line box 500. A plurality of electronic identity sensors such as radio frequency identification (“RFID”) readers 90 are positioned in container handling system 500 alongside the rail lines at various strategic locations. For example and as shown in the illustrated embodiment, an RFID reader can be located adjacent to a rail line “feeding” a transfer stack region. The actual number and placement of RFID readers 90 can be varied without departing from the scope of the present invention. RFID readers 90 are positioned to read RFID tags (not shown) that are generally mounted on each rail car. Information included in such RFID tags can include, for example, rail car identity, rail car ownership, current origin/destination for the rail car, etc., as is well understood in the art. This allows container handling system 500 to maintain an exact inventory of rail cars and their itinerary.

Each RFID reader 90 is coupled to a yard controller 92 using hard-wire or wireless communications. For clarity of illustration, only one RFID reader 90 is shown coupled to yard controller 92. Yard controller 92 is provided with incoming/outgoing train and vessel manifests as well as the occupancy/vacancy status of each transfer stack region 54. An RFID reader 90 provides yard controller 92 with train information as a train passes a RFID reader 90 such that yard controller 92 can control the various rail line switches (e.g., 51A, 51B, 52D, 52E) to direct a train to an optimal transfer stack region 54.

Yard controller 92 receives occupancy/vacancy status for a transfer stack region via a transfer stack controller 94 generally coupled to a transfer stack region's RMG 60. Once again, for clarity of illustration only one transfer stack controller 94 is shown coupled to yard controller 92. Movement of containers within a transfer stack region 54, from a transfer stack region 54 to dock 200, or from dock 200 to a transfer stack region 54, can be controlled “locally” by a transfer stack controller 94 or “globally” by yard controller 92 acting through a transfer stack controller 94.

Transfer stack regions of the present invention could also be equipped with additional features. For example, switches along each branch line 51B could be remotely controlled by an operator stationed in a control booth (not shown) provided at each transfer stack region 54. Container area 76 could include reefer racks to provide the necessary electricity for containers equipped with refrigeration units.

The advantages of the present invention are numerous. The container handling system provides for direct rail-to-dock and dock-to-rail container transfers. Buffer zones and port vehicles are eliminated thereby greatly increasing throughput efficiency, decreasing costs, and improving safety. The placement of rail lines, container rows and import/export portal equipment within an RMG “footprint” (i.e., a transfer stack region) provides the structure needed for complete automation of rail-to-dock and dock-to-rail container handling.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A land-based shipping container handling system, comprising:
at least one transfer stack region, each said transfer stack region including
a rail mounted gantry (RMG) defining a three-dimensional operating region,
at least one rail line disposed on the ground in said operating region and extending therefrom,
a land area defined on the ground in said operating region, said land area being adjacent to said at least one rail line and adapted to support storage of at least one row of shipping containers,
an elevated platform disposed at one end of said operating region at an upper portion of said operating region, and
attribute sensing equipment mounted on said elevated platform.

2. A land-based shipping container handling system as in claim 1, further comprising a train marshaling yard disposed on the ground, said train marshaling yard coupled to said at least one rail line for support of train travel therebetween.

3. A land-based shipping container handling system as in claim 1, further comprising at least one elevated walkway disposed on the ground in said operating region and alongside said at least one rail line.

4. A land-based shipping container handling system as in claim 1, further comprising:
at least one identity sensor positioned along said at least one rail line extending from said operating region, each said identity sensor capturing data associated with a train rail car passing thereby; and
a controller coupled to each said identity sensor for receiving said data captured by each said identity sensor.

5. A land-based shipping container handling system as in claim 4, wherein said controller provides control commands to said RMG based on said data.

6. A land-based shipping container handling system as in claim 4, wherein each said identity sensor comprises a radio frequency identification (RFID) reader.

7. A land-based shipping container handling system for a dockside land parcel that includes a dock, comprising:
a train marshaling yard on the ground of a dockside land parcel; and
a plurality of transfer stack regions at the dockside land parcel, each of said transfer stack regions having one end adjacent to a dock at the dockside land parcel, each of said transfer stack regions including
a rail mounted gantry (RMG) defining a three-dimensional operating region that includes and extends up from the ground,
at least one rail line disposed on the ground in said operating region and extending therefrom for coupling to said train marshaling yard,
a land area defined on the ground in said operating region, said land area being adjacent to said at least one rail line and adapted to support storage of at least one row of shipping containers, wherein shipping containers are stackable in each said row up to the top of said operating region,
an elevated platform disposed at said one end of said operating region adjacent to the dock and at an upper portion of said operating region, and
attribute sensing equipment mounted on said elevated platform.

8. A land-based shipping container handling system as in claim 7, further comprising at least one elevated walkway disposed on the ground in said operating region and alongside each said rail line.

9. A land-based shipping container handling system as in claim 7, further comprising:
at least one identity sensor positioned along said at least one rail line extending from said operating region, each said identity sensor capturing data associated with a train rail car passing thereby; and
a controller coupled to each said identity sensor for receiving said data captured by each said identity sensor.

10. A land-based shipping container handling system as in claim 9, wherein said controller provides control commands to said RMG based on said data.

11. A land-based shipping container handling system as in claim 9, wherein each said identity sensor comprises a radio frequency identification (RFID) reader.

12. A land-based shipping container handling system, comprising:
at least one transfer stack region, each said transfer stack region including
a rail mounted gantry (RMG) defining a three-dimensional operating region that includes and extends up from the ground,
a plurality of adjacent and parallel rail lines disposed on the ground in said operating region and extending therefrom,
at least one elevated walkway disposed on the ground in said operating region and alongside at least one of said rail lines,
a land area defined on the ground in said operating region, said land area being adjacent to said rail lines and adapted to support storage of a plurality of adjacent and parallel rows of shipping containers,
an elevated platform disposed at one end of said operating region at an upper portion of said operating region, and
attribute sensing equipment mounted on said elevated platform.

13. A land-based shipping container handling system as in claim 12, further comprising a train marshaling yard disposed on the ground, said train marshaling yard coupled to said rail lines for support of train travel therebetween.

13. A land-based shipping container handling system as in claim 12, further comprising:
at least one identity sensor positioned along said rail lines extending from said operating region, each said identity sensor capturing data associated with a train rail car passing thereby; and
a controller coupled to each said identity sensor for receiving said data captured by each said identity sensor.

14. A land-based shipping container handling system as in claim 13, wherein said controller provides control commands to said RMG based on said data.

15. A land-based shipping container handling system as in claim 13, wherein each said identity sensor comprises a radio frequency identification (RFID) reader.

16. A method of operating a land-based shipping container handling system, comprising the steps of:
providing a plurality of transfer stack regions at the dockside land parcel, each of said transfer stack regions having one end adjacent to a dock at the dockside land parcel, each of said transfer stack regions including
a rail mounted gantry (RMG) defining a three-dimensional operating region that includes and extends up from the ground,
at least one rail line disposed on the ground in said operating region and extending therefrom,
a land area defined on the ground in said operating region, said land area being adjacent to said at least one rail line and adapted to support storage of at least one row of shipping containers, wherein shipping containers are stackable in each said row up to the top of said operating region,
an elevated platform disposed at said one end of said operating region adjacent to the dock and at an upper portion of said operating region, and
attribute sensing equipment mounted on said elevated platform;
transferring shipping containers between said operating region and the dock using said RMG; and
exposing each of the shipping containers being transferred to said attribute sensing equipment during said step of transferring.

17. A method according to claim 16, wherein said step of transferring includes the step of removing at least a portion of the shipping containers being transferred to the dock directly from train rail cars on said at least one rail line in said operating region.

18. A method according to claim 16, wherein said step of transferring includes the step of placing at least a portion of the shipping containers being transferred from the dock directly onto train rail cars on said at least one rail line in said operating region.
